(19) United States
(12) Patent Application Publication
(10) Pub. No.: US 2008/0005149 A1
(43) Pub. Date: Jan. 3, 2008

(54) Collection presentation

(75) Inventor: Robert K. McAfee, San Jose, CA (US)

Correspondence Address: KOKKA & BACKUS, PC, 200 PAGE MILL ROAD, SUITE 103, PALO ALTO, CA, 94306, US

(73) Assignee: Adobe Systems Incorporated, San Jose, CA (US)

(21) Appl. No.: 11/479,304

(22) Filed: Jun. 29, 2006

(51) Int. Cl. G06F 7/00

(52) U.S. Cl. 707/102

(57) ABSTRACT

Collection presentation is described, including displaying a collection in an environment, the collection having one or more files, the data associated with each of the one or more files being displayed in a collection display pane, identifying a file from the one or more files, the file being displayed in a preview display pane configured to receive an input to modify the file, receiving the input to modify the file, a modification being made to a temporary file associated with the file and the modification being based on the input, and implementing the modification from the temporary file to the file when another input is received.

### FIELD OF THE INVENTION

The present invention relates generally to software architecture and user interfaces. More specifically, collection presentation described.

### BACKGROUND OF THE INVENTION

Files (e.g., electronic documents, spreadsheets, images, graphics, video, audio, or other types of formatted documents) can be assembled in groups or collections of files. Files are often grouped into collections to indicate a relationship among the files based on context, content, or other factors. For example, forms used for a job application, a reference manual, a family of images, or the like may be grouped together in a collection. Although files in a collection can be viewed, conventional solutions are problematic for several reasons.

In some conventional solutions, files in a collection are displayed in a folder. However, in order to view the files, different native applications are used for different file formats and file associations. In other words, when a collection of files are viewed using conventional solutions, one file is opened in an application, but other files may require other applications in order to view them. In other conventional solutions, summary data (e.g., icons, brief file descriptions, general file parameters (e.g., size, modification date, and the like) is presented, but the interface used to view the summary data is typically different than the applications that are used to view the files. Further, conventional solutions that allow files to be previewed do not permit actions other than viewing the file. Modifications, data entry, editing, or other functions are typically performed using native applications associated with the file formats of each file. Conventionally, collections of files are often displayed using metadata or cursory, summary data, which typically does not provide information other than the name, type, format, modification date, or content of a file. Icons (e.g., envelopes, paper clips, or logos associated with the application in which the file was authored or modified) are often used to indicate that a file is present, but data is often limited to the title, date of last modification, and file size (in bits or bytes). In order to determine the type, form, format, or content of a file, a user is typically required to open the file, which may launch another application if there are files with different file formats or associations, resulting in both time and processor delays while different applications are launched. Further, if an attachment (i.e., a file attached to another file) is present, conventional solutions typically permit display of the host file (i.e., the file to which the attachment is attached) and not the attachment.

Thus, a solution for presenting collections of files without the limitations of conventional techniques is needed.

### BRIEF DESCRIPTION OF THE DRAWINGS

Various examples are disclosed in the following detailed description and the accompanying drawings:

FIG. 1 illustrates an exemplary collection presentation system;

FIG. 2 illustrates an exemplary attachment handling module;

FIG. 3A illustrates an exemplary collection presentation environment;

FIG. 3B illustrates an alternative exemplary collection presentation environment;

FIG. 4 illustrates an exemplary collection presentation configuration interface;

FIG. 5 illustrates an exemplary overall process for collection presentation;

FIG. 6 illustrates an exemplary process for processing an input for collection presentation; and

FIG. 7 illustrates an exemplary computer system suitable for collection presentation.

### DETAILED DESCRIPTION

Various embodiments or examples may be implemented in numerous ways, including as a system, a process, an apparatus, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided as examples and the described techniques may be practiced according to the claims without some or all of the accompanying details. For clarity, technical material that is known in the technical fields related to the embodiments has not been described in detail to avoid unnecessarily obscuring the description.

Collections of files (e.g., groups of documents, images, graphics, video, audio, or other data that may be configured, represented, displayed, or otherwise presented together) may be displayed in a display or graphical user interface environment (“environment”) that is configured to present (i.e., display) the collection of files, selected files, and attachments to the files. In some examples, collections may be files that are grouped together on a common disk, folder, or other storage repository. Collections may also be groups of documents, images, graphics, video, audio, or other types of data files that may be logically represented together, sharing a common characteristic, having similar metadata, or the like. Data (e.g., form data, metadata, and the like) associated with each file within a collection, a file selected from the collection, or an attachment may be presented in an environment simultaneously or substantially simultaneously. In some examples, a collection may be viewed in a collection display pane while displaying one or more files selected from the collection in a preview display pane. Receiving input through an interface (e.g., graphical user interface (“GUI”), processor-to-processor interface, system interface, and others), modifications or changes (“modifications”) may be made to a collection or file within the collection using an interface configured to receive, implement, and save the modifications. In some examples, modifications (e.g., addition, deletion, or other modification of data) may be made to a file by making the modifications to a temporary or cached (“temporary”) file that are later copied to the selected file. Modifications may be made, but when a file or collection is closed or another file is selected (e.g., another file in a collection, an attachment), modifications may be made to a host file (i.e., root document) when the environment is closed. In other words, modifications may be made to a temporary file until a collection or file is closed, thus modifying a host file associated with the temporary file. The described techniques may be varied and are not limited to the examples provided.

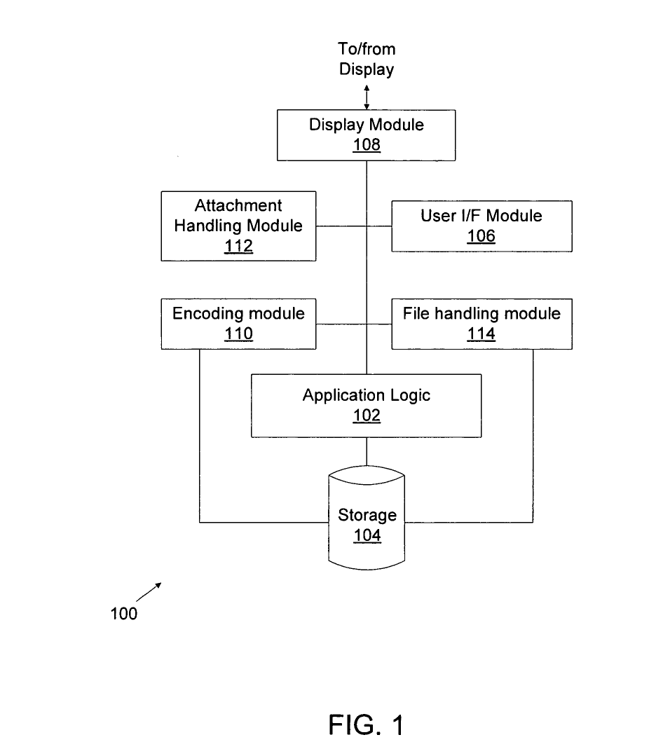

FIG. 1 illustrates an exemplary collection presentation system. Here, system 100 includes application logic 102, storage 104, user interface module 106, display module 108, encoding module 110, attachment handling module 112, and file handling module 114. In some examples, some, all, or none of system 100 and the above-listed elements may be implemented as part of another application such as those described herein or as a separate, standalone application. Application logic 102 may be part of an application configured to implement the described techniques for collection presentation. For example, core application logic 102 may be implemented as control logic in an application used for working with files for a variety of purposes, including office productivity, word processing, spreadsheet, data management, contact management, enterprise resource management, creative editing or authoring applications, and the like.

In some examples, a command, signal, instruction, or other input (“input”) may be provided by a user and received by system 100 via user interface (“I/F”) module 106. When requested, files and temporary files may be stored in or retrieved from storage 104, which may be accessed by core application logic 102, encoding module 110, or file handling module 114. Storage 104 may be a local or remote database, repository, cache, data warehouse, storage area network, storage array, or other data structure used to store data associated with files. In some examples, data may be metadata, content, parameters, settings, formatting information, or other data used to determine how and what to present for a given file. In other examples, data may include other types of information.

Here, presentation of files and collections may be performed by retrieving files from storage 104. In some examples, file handling module 114 and encoding module 110 may be used to provide data that is rendered for display on a user interface by display module 108. In other examples, presentation of files and collections may be performed differently and is not limited to the examples provided above. Further, system 100 and its above-described elements may be implemented as applications, computer programs, software, or code used to implement the described techniques may be developed using various types of structured or unstructured programming and formatting languages such as C, C++, C#, .Net, Java, Cobol, FORTRAN, ADA, HTML, XML, XHTML, and others. The types of programming or formatting languages used are not intended to be either limiting or comprehensive and may be varied.

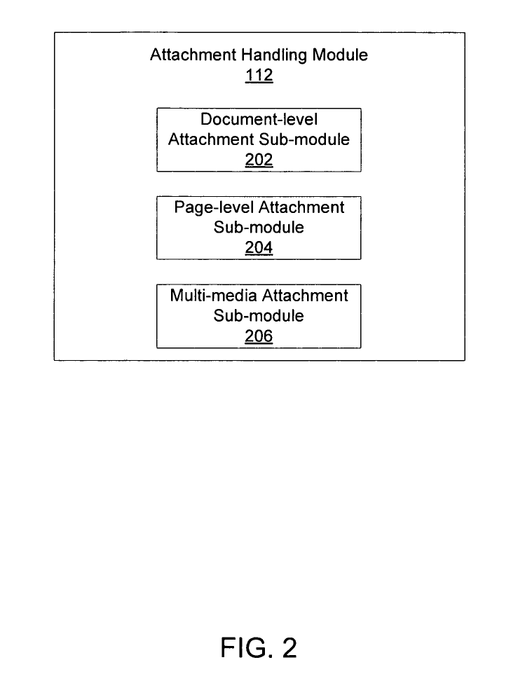

FIG. 2 illustrates an exemplary attachment handling module. Here, attachment handling module 112 includes document-level attachment sub-module 202, page-level attachment sub-module 204, and multi-media attachment sub-module 206. In some examples, attachment handling module 112 may be used to retrieve, process, render, or perform other operations associated with presenting files or collections. An attachment may be a file that is attached (i.e., electronically attached, included, appended, pre-pended, cross-referenced, linked, hyperlinked, or otherwise associated) to another file. For example, if a collection is presented and a file is selected for viewing, an attachment may be included within the selected file. In some examples, when an attachment is selected (i.e., a user indicates, instructs, signals, or otherwise provides an input to open), attachment handling module 112 may be used to determine the type (e.g., format, display parameters or settings, configuration, content, and the like) of file for the attachment. After determining the type of file for the attachment, rendering, display, and other presentation data may be provided by attachment handling module 112 to display module 108 for presentation on a system display (e.g., a computer monitor, screen, liquid crystal display (LCD), television (TV), or other display device). In other examples, attachment handling module 112 may be implemented differently and include more or fewer modules apart from those shown and described.

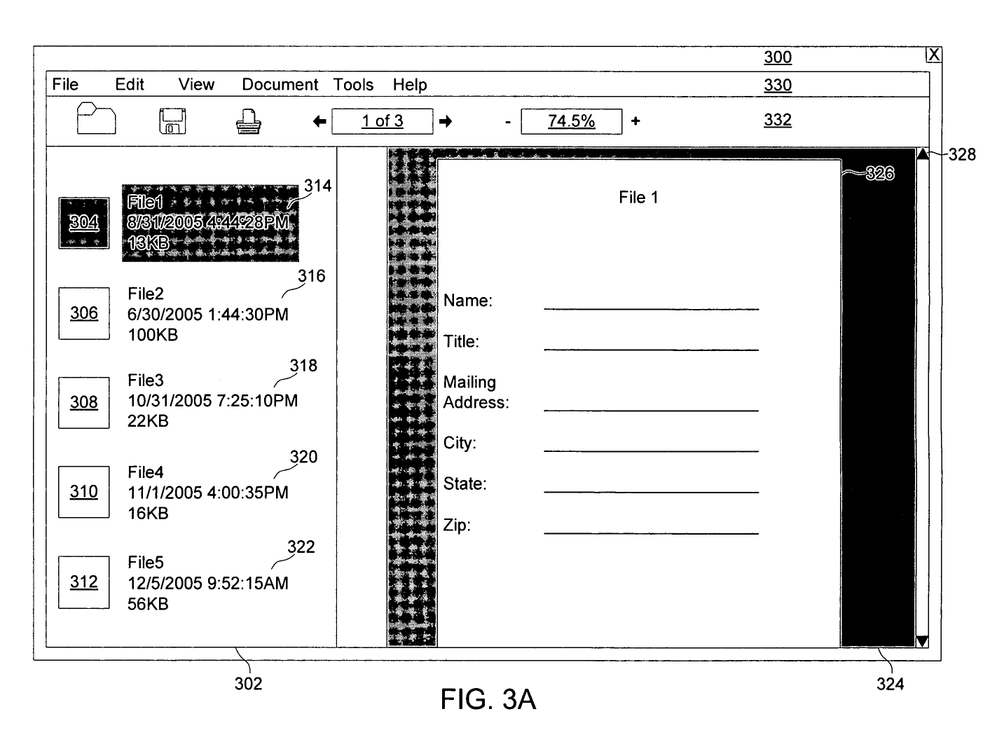

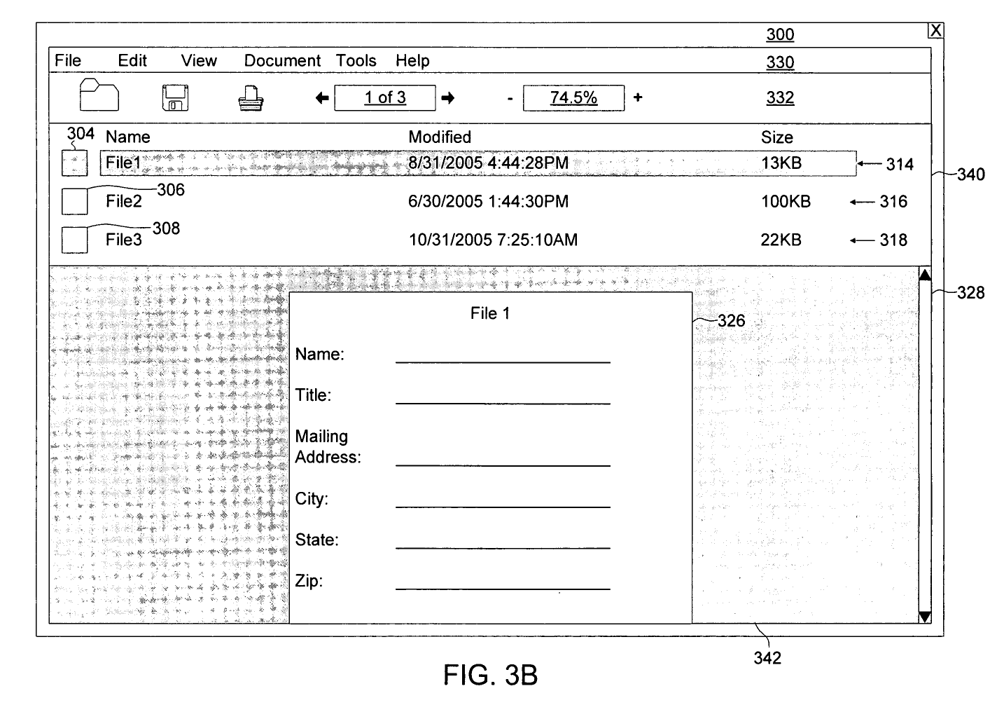

FIG. 3A illustrates an exemplary collection presentation environment. Here, display environment (“environment”) 300 is shown, including collection display pane 302, icons 304-312, file descriptions 314-322, preview display pane 324, file 326, scroll bar 328, menu bar 330, and sub-menu bar 332. In some examples, environment 300 may be used to view a collection of files in collection display pane 302. Substantially simultaneous with viewing a collection of files in collection display pane 302, a file may be selected and viewed in preview display pane 324. When a file (e.g., file 326) is viewed in preview display pane 324, modifications may be made to the file. When another file is selected, an attachment is opened, or if the current file is closed, modifications made to file 326 may be copied from a temporary file to a host file associated with file 326. In addition to viewing the collection of files, files that are selected and viewed may also be modified in environment 300, which provides an interface to permit presentation, viewing, modification, retrieval, storage, and other uses of files without using multiple or different applications. In other examples, file 326 may be viewed in environment 300 and preview display pane 324 without regard to any particular type of file association (e.g., .doc, zip, .pdf, .jpg, .mpeg, .xls, .ppt, .swf, and the others).

In some examples, when a collection is viewed in collection display pane 302, icons 304-312 and data (e.g., file descriptions 314-322) may be presented. However, in addition to providing iconic representations and descriptions of files, a selected file (e.g., file 1 as indicated by the shaded icon 304 and file description 314) may be viewed in preview display pane 324. Here, preview display pane 324 permits functions beyond viewing, including, but not limited to, modification and editing, deleting, adding, or otherwise working with attachments included with the file (file 326) being viewed in preview display pane 324. For example, file 326 is a form with several fields of information that may be entered using environment 300 and preview display pane 324. In addition to entering information into the fields of file 326, other functions may be performed, such as changing the page view (shown here as “1 of 3”), increasing or decreasing the scaling factor (shown here as “74.5%”), opening, saving, printing, and the like. Functions may be selected using menus (e.g., pull down menus) such as those shown in menu bar 330 or by manipulating icons such as those provided in sub-menu bar 332. For example, if an icon representing a “save” function is selected, modifications made to file 326 may be copied from a temporary file to the selected host file (i.e., “filel”). As another example, if a print function (e.g., an icon, drop-down menu selection, or other option) is selected, modifications made to file 326 may be copied from a temporary file to the selected host file, which is then sent to a printer queue associated with a printer. In still other examples, print functions associated with environment 300 may be implemented differently and are not limited to those described above. Further, environment 300 and the elements, functions, and other aspects shown and described above may be varied and are not limited in design, function, or implementation to the examples provided.

FIG. 3B illustrates an alternative exemplary collection presentation environment. Here, display environment (“environment”) 300 is shown again, including icons 304-308, file descriptions 314-318, file 326, scroll bar 328, menu bar 330, and sub-menu bar 332. In some examples, an alternate layout configuration may be used, as shown by collection display pane 340 and preview display pane 342. Here, a horizontal layout is provided, presenting icons 304-308 and file descriptions 314-318 in collection display pane 340 and file 326 in preview display pane 342. As an alternate, environment 300 may be used to permit wider viewing of file 326. Further, additional information associated with files 1-3 (e.g., file descriptions 314-318) may be provided in collection display pane 340. For example, “Name,” “Modified” date, and “Size” are labels for various attributes of each file in a collection. However, other attributes, characteristics, parameters, data, or information associated with each file in a collection can be presented in collection display pane 340. Further, other layout configurations other than those shown and described above may be implemented and are not limited to the examples provided. For example, another alternate layout for collection presentation may include presenting an icon, file description, and presentation of each file by combining the previously described collection display pane 340 and preview display pane 342 into a single pane presented in environment 300. In other words, instead of two panes within environment 300, a single pane may be used to present both data and information regarding a collection as well as selected files and attachments belonging to the collection. The above-described examples may be varied in design, function, and implementation and are not limited to the descriptions provided.

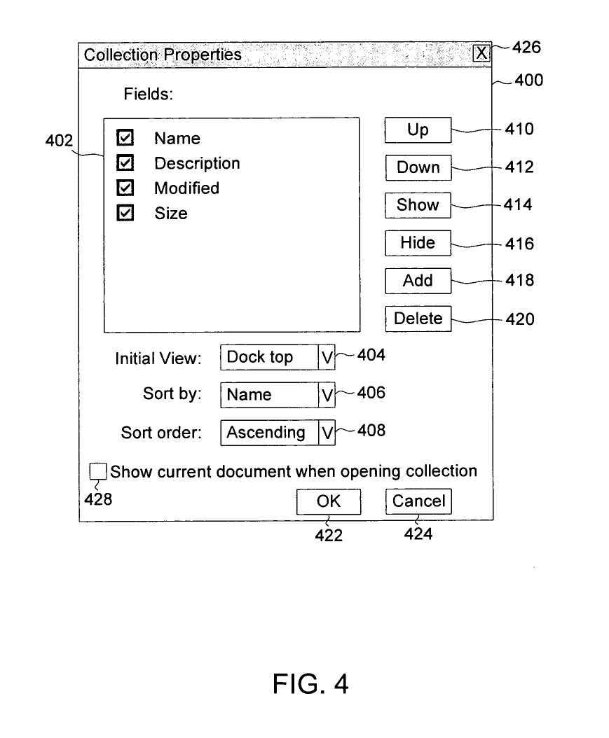

FIG. 4 illustrates an exemplary collection presentation configuration interface. Here, interface 400 is shown, including pane 402, pull-down menus 404-408, buttons 410-426, and option 428. In some examples, interface 400 may be used to provide configuration information, parameters, and other data for collection presentation or modifying the properties of a collection. For example, certain fields may be selected for appearance in file descriptions 314-322 (FIG. 3A). By selecting (i.e., “checking”) or deselecting (i.e., “unchecking”) boxes provided in pane 402 and buttons 410-420, field descriptions 314-322 may be presented differently in collection display pane 302 (FIG. 3A). Further, selecting options from pull-down menus 404-408 may also be used to present a collection, selected files, and attachments in interface 400 differently.

Here, pull-down menu 404 may be used to determine an initial view for a collection presentation. Further, pull-down menus 406-408 may be used to sort files in a collection based on an attribute such as a file name and in an ascending order, respectively. In other examples, attributes such as the file size, date of last modification, or other information may be used to sort the files in a collection and, thus, options providing for these attributes may be provided by pull-down menu 406. In still other examples, files may be sorted in different orders, including descending, alphabetical, alphanumerical, and the like. Interface 400 may be configured differently and is not limited to the aspects, features, or functionality shown and described.

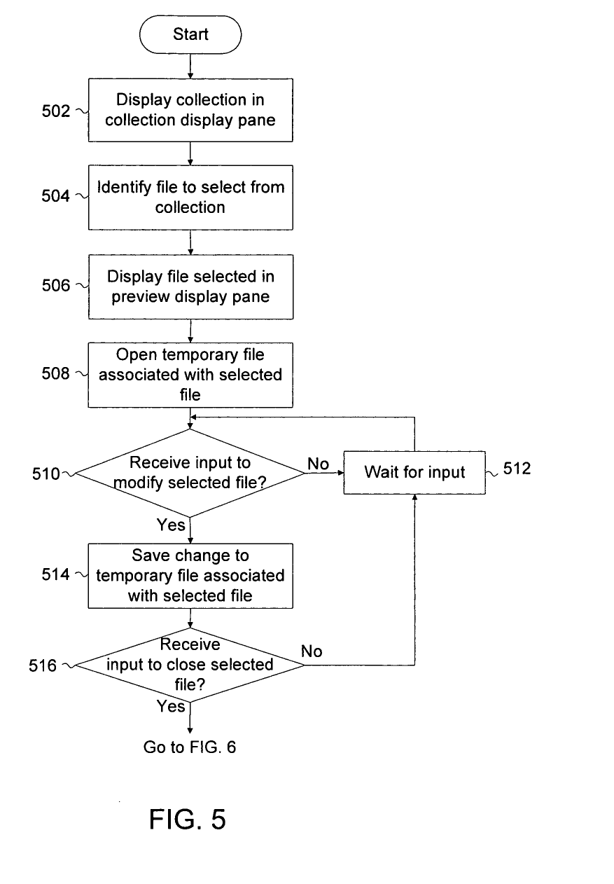

FIG. 5 illustrates an exemplary overall process for collection presentation. Here, a collection is displayed in a collection display pane (502). In some examples, presenting a collection may include displaying icons, file descriptions, attributes, or characteristics, or other parameters in order to provide a summary view of the files grouped together into a collection. In other examples, metadata may be evaluated to determine what attributes, characteristics, or other parameters should be presented in an environment (e.g., collection display pane (302) (FIG. 3A)). When a collection is presented, a file is identified for presentation in a preview display pane (e.g., preview display pane 324 (FIG. 3A)) (504). In some examples, files may be system or application-identified when a user input is received that determines which file is selected. After identifying a file for presentation from a collection, the file is displayed (506). Either concurrent to displaying the selected file or after displaying the selected file, a temporary file associated with the selected file is opened (508). In some examples, a temporary file may be used to save changes or modifications to a selected file while a collection is opened. Temporary files may be opened for a collection, files within a collection, or attachments (i.e., files attached to other files). When modifications are made, a temporary file is used to capture the modifications and, when a collection or selected file is closed, the changes are cascaded or made to the selected file within the selection. In other words, modifications are not made to a selected file until after the selected file has been closed. Likewise, modifications are not made to a collection until the collection has been closed. In some examples, attachments may be other files within a collection. Attachments may also be of various types such as files attached to other files (i.e., document-level file attachments), files attached to pages of another file (i.e., page-level file attachments), or files of various types of media formats (i.e., multi-media file attachments), including video, audio, graphical, and the like. Other types of attachments may be used with the described techniques, which are not limited to the examples provided.

In some examples, after a temporary file has been opened for a selected file, collection, or attachment, a determination is made as to whether an input has been received to modify the selected file (510). If no input has been received indicating a modification to the selected file (i.e., an open, temporary file), then a wait is incurred for the reception of an input indicating a modification (512). Alternatively, if an input is received indicating a modification, it is saved to the temporary file (514). Another determination is then made as to whether another input is received to close the selected file (516). If the received input indicates closure of the selected file, then the selected file is closed (518). Alternatively, a delay or wait is incurred if another input has not been received (512).

In some examples, a selected file may be closed, resulting in modifications being copied from the temporary file to the selected file (i.e., host file or root document). When another file is selected for presentation in, for example, preview display pane 324 (FIG. 3A), the current selected file is closed along with its temporary file. Modifications stored in the temporary file are then transferred (i.e., copied) to the actual selected file, which may be stored in a repository (e.g., storage 104 (FIG. 1)). When a modification is made from the temporary file to the selected file, the selected file enters a “dirty” condition. In other words, a “dirty” file is a file belonging to a collection where modifications were made to the file when it was selected. The above-described process may be varied and is not limited to the examples provided above.

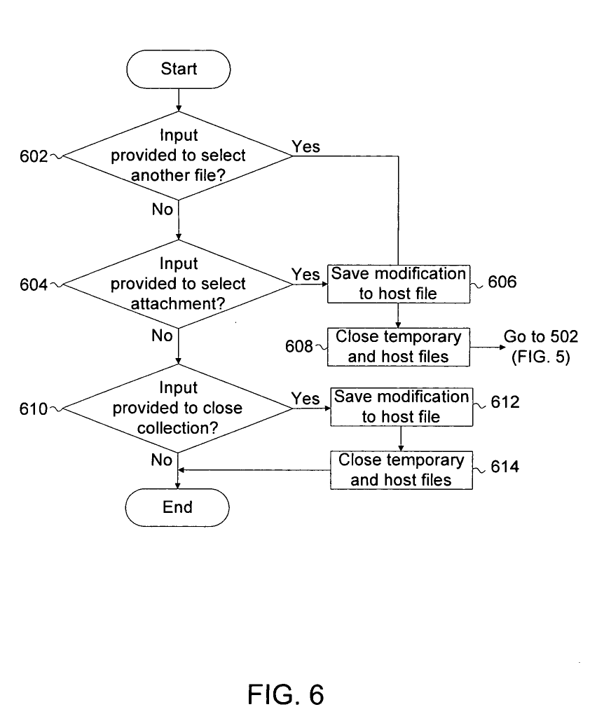

FIG. 6 illustrates an exemplary process for processing an input for collection presentation. The below-described process provides for processing another input is received to close the selected file (516 (FIG. 5)). Other alternative process may be used and the described collection presentation techniques are not limited to the examples provided. Here, when another input is received, a determination is made as to whether the input indicates the selection of another file (602). In other words, a determination is made as to whether a file other than the current selected file has been identified for presentation in environment 300 (FIG. 3). If another file has not been selected, then a determination is made as to whether an attachment within the selected file has been identified (i.e., document-level file attachment, page-level file attachment, multi-media file attachment, and others) (604). If another file or an attachment has been selected, then modifications are saved from the temporary file of the current selected file to the actual selected file (i.e., host file or root document). After saving the modifications to the temporary file, the current selected file is closed (608) and the newly-identified selected file or attachment is opened and presented in environment 300 (FIG. 3), which results in a new temporary file also being opened (502 (FIG. 5)).

Alternatively, if the received input does not identify the selection of another file or a file attachment, then a determination is made as to whether the input indicates whether the current selected file or current open collection is to be closed (610). If the input indicates closure of the selected file or current collection without identifying the selection of another file, collection, or attachment, then the modifications made to the temporary file for the current selected file are saved to the selected file (i.e., the host file or root document) (614). Once saved (i.e., the modifications are copied from the temporary file to the host file or root document), then the current selected file (i.e., temporary and host file or root document) or collection is closed (614). In other examples, the above-described process may be varied and is not limited to the description provided.

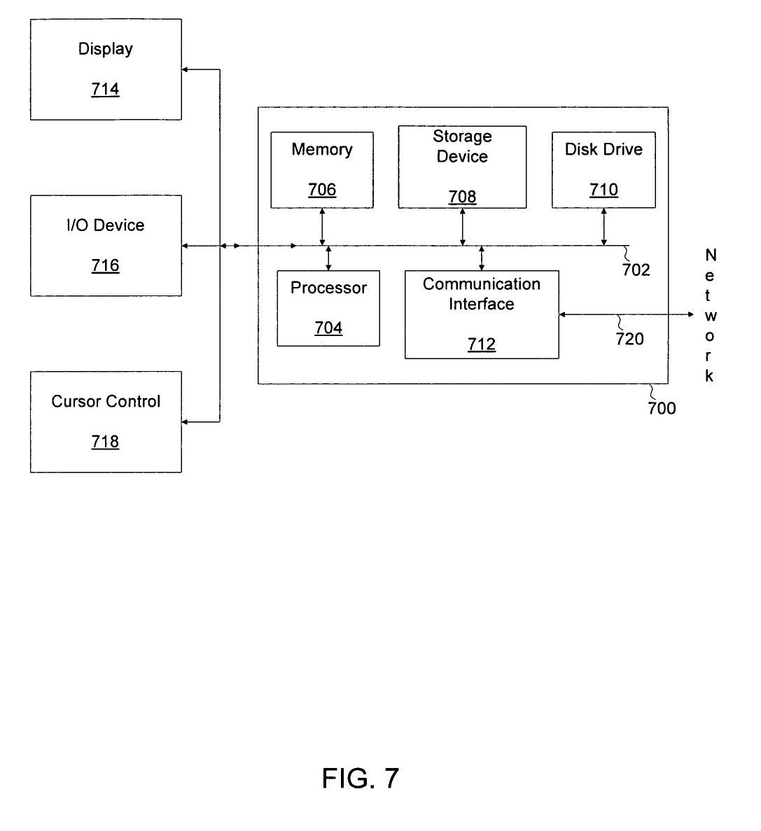

FIG. 7 illustrates an exemplary computer system suitable for collection presentation. In some examples, computer system 700 may be used to implement computer programs, applications, methods, processes, or other software to perform the above-described techniques. Computer system 700 includes a bus 702 or other communication mechanism for communicating information, which interconnects subsystems and devices, such as processor 704, system memory 706 (e.g., RAM), storage device 708 (e.g., ROM), disk drive 710 (e.g., magnetic or optical), communication interface 712 (e.g., modem or Ethernet card), display 714 (e.g., CRT or LCD), input device 716 (e.g., keyboard), and cursor control 718 (e.g., mouse or trackball).

According to some examples, computer system 700 performs specific operations by processor 704 executing one or more sequences of one or more instructions stored in system memory 706. Such instructions may be read into system memory 706 from another computer readable medium, such as static storage device 708 or disk drive 710. In some examples, hard-wired circuitry may be used in place of or in combination with software instructions for implementation.

The term “computer readable medium” refers to any medium that participates in providing instructions to processor 704 for execution. Such a medium may take many forms, including but not limited to, non-volatile media, volatile media, and transmission media. Non-volatile media includes, for example, optical or magnetic disks, such as disk drive 710. Volatile media includes dynamic memory, such as system memory 706. Transmission media includes coaxial cables, copper wire, and fiber optics, including wires that comprise bus 702. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some examples, execution of the sequences of instructions may be performed by a single computer system 700. According to some examples, two or more computer systems 700 coupled by communication link 720 (e.g., LAN, PSTN, or wireless network) may perform the sequence of instructions in coordination with one another. Computer system 700 may transmit and receive messages, data, and instructions, including program, i.e., application code, through communication link 720 and communication interface 712. Received program code may be executed by processor 704 as it is received, and/or stored in disk drive 710, or other non-volatile storage for later execution.

The foregoing examples have been described in some detail for purposes of clarity of understanding, but are not limited to the details provided. There are many alternative ways and techniques for implementation. The disclosed examples are illustrative and not restrictive.

What is claimed:

1. A method, comprising:
displaying a collection in an environment, the collection having one or more files, wherein data associated with each of the one or more files is displayed in a collection display pane;
identifying a file from the one or more files, the file being displayed in a preview display pane configured to receive an input to modify the file;
receiving the input to modify the file, a modification being made to a temporary file associated with the file and the modification being based on the input; and
implementing the modification from the temporary file to the file when another input is received.

2. The method recited in claim 1, wherein the collection and the file are displayed substantially simultaneously in the environment.

3. The method recited in claim 1, wherein at least one of the one or more files and an attachment associated with the at least one of the one or more files are displayed substantially simultaneously in the environment.

4. The method recited in claim 1, wherein the another input indicates printing at least one of the one or more files.

5. The method recited in claim 1, wherein the another input indicates closing the collection.

6. The method recited in claim 1, wherein the another input indicates saving the collection.

7. The method recited in claim 1, wherein the one or more files comprise a document-level attachment.

8. The method recited in claim 1, wherein the one or more files comprise a page-level attachment.

9. The method recited in claim 1, wherein the one or more files comprise a multi-media attachment.

10. The method recited in claim 1, wherein the collection display pane and the preview display pane are displayed substantially simultaneously in the environment.

11. The method recited in claim 1, wherein implementing the modification from the temporary file to the file comprises making the modification to the file.

12. A method, comprising:
presenting a plurality of files, each of the plurality of files being associated with data displayed in a collection display pane in an environment;
identifying a selected file from the plurality of files;
displaying the selected file in a preview display pane, the preview display pane being presented in the environment;
modifying the selected file in response to an input, a modification being made to a temporary file associated with the selected file and the modification being based on the input; and
saving the modification to the selected file when another input is received.

13. The method recited in claim 12, wherein the data and the selected file are displayed substantially simultaneously in the environment.

14. The method recited in claim 12, wherein at least one of the plurality of files and an attachment associated with the at least one of the plurality of files are displayed substantially simultaneously in the environment.

15. The method recited in claim 12, wherein the another input indicates printing the plurality of files, wherein each of the plurality of files is printed.

16. The method recited in claim 12, wherein the another input indicates printing at least one of the plurality of files.

17. The method recited in claim 12, wherein the another input indicates printing the selected file, wherein the selected file is printed with the modification.

18. The method recited in claim 12, wherein the another input indicates closing the environment.

19. The method recited in claim 12, wherein the another input identifies another selected file.

20. A system, comprising:
a memory configured to store data associated with a collection, the collection having one or more files; and
logic configured to display a collection, the collection having one or more files, wherein data associated with the one or more files is displayed in a collection display pane, to identify a file from the one or more files, the file being displayed in a preview display pane configured to receive an input to modify the file, a modification being made to a temporary file associated with the file and the modification being based on the input, and to implement the modification to the file when another input is received to save the collection.

21. A system, comprising:
an environment configured to display a collection comprising a plurality of files, the environment comprising a collection display pane and a preview display pane, wherein the collection display pane is configured to display data associated with the plurality of files and the preview display pane is configured to display a selected file selected from the plurality of files;
an interface configured to receive an input to modify the selected file, wherein a modification is made to a temporary file associated with the selected file when the input is received; and
a memory configured to save the modification to the selected file when another input is received.

22. The system of claim 21, wherein the another input is provided to close the environment.

23. The system of claim 21, wherein the another input is provided to select another selected file.

24. A computer program product embodied in a computer readable medium and comprising computer instructions for:
displaying a collection in an environment, the collection having one or more files, wherein data associated with each of the one or more files is displayed in a collection display pane;
identifying a file from the one or more files, the file being displayed in a preview display pane configured to receive an input to modify the file;
receiving the input to modify the file, a modification being made to a temporary file associated with the file and the modification being based on the input; and
implementing the modification from the temporary file to the file when another input is received.

25. A computer program product embodied in a computer readable medium and comprising computer instructions for:
presenting a plurality of files, each of the plurality of files being associated with data displayed in a collection display pane in an environment;
identifying a selected file from the plurality of files;
displaying the selected file in a preview display pane, the preview display pane being presented in the environment;
modifying the selected file in response to an input, a modification being made to a temporary file associated with the selected file and the modification being based on the input; and
saving the modification to the selected file when another input is received.
